(19) United States
(12) Patent Application Publication
(10) Pub. No.: US 2015/0108140 A1
(43) Pub. Date: Apr. 23, 2015

(54) Press Lock Cooker for Making Poultry, Meat and Fish

(71) Applicant: Albert Ivatorov, Brooklyn, NY (US)

(72) Inventor: Albert Ivatorov, Brooklyn, NY (US)

(21) Appl. No.: 14/057,143

(22) Filed: Oct. 18, 2013

(51) Int. Cl. A47J 27/08; B65D 43/02; B65D 81/38; B65D 25/28

(52) U.S. Cl. CPC A47J 27/0815; B65D 25/2805; B65D 43/0204; B65D 81/38
USPC 220/573.1

(57) ABSTRACT

An inexpensive, cost-effective press lock cooker for cooking poultry, meat, and fish. The press lock cooker allows the user to simply, quickly, and inexpensively cook poultry, meat, and fish of varying sizes and shapes in the restaurant or home environment by simply locking the cover over the food to be cooked and by optionally adjusting the height of the cover over the food to regulate the food's contact surface with the frying pan, the thickness of the poultry, meat, and fish that is cooked, the time it takes to cook, and the crispiness of the food.

### BACKGROUND

This invention relates to making poultry, meat, and fish in a commercial (restaurant or cafe) or home environment. Using the press lock cooker of the present invention, anyone can make fresh, delicious poultry, meat, and fish with just the right tools. Although primarily aimed at commercial use, the press lock cooker for making poultry, meat, and fish of the present invention can also be successfully used at home for making fresh fried poultry, meat, and fish to order.

Poultry, meat, and fish are popular restaurant and home-cooked dishes with adults and children alike. Currently, there is a number of ways to make fried poultry, meat, and fish as fully disclosed in the brief description of the prior art, but none are so easy and simple to use as the inexpensive press lock cooker of the present invention.

In addition to being inexpensive, the press lock cooker can vary regulate the thickness of the poultry, meat, and fish that are being cooked by simply varying the height of the adjustable press. Furthermore, the user can regulate how fast the food cooks by adjusting the pressure applied to the food. Poultry, for example chicken, may be cooked crispy with the press lock cooker. Thus, the consumers—both chefs at restaurants and moms making dinner at home—have the control over the thickness of the final dish and how fast it cooks.

### DESCRIPTION OF PRIOR ART

The current state of the art involves frying poultry, including chicken, meat, including steaks, burgers and chops, and fish using either two-sided grills with a pair of pivotally-connected cooking plates or griddles, using a heavy, weighted press with a plate that presses the food down while it is being cooked, or using a handheld press, applying pressure to the food manually exerting force through the handle. This is done to ensure the better contact of the food with the frying pan, and to prevent the sides from curling from the heat. The improved contact between the food and the pan ensures better heat distribution through the food and helps the user regulate how fast, and how thoroughly, the food cooks.

However, neither of these methods provides a great degree of adjustability because the weight of the food press remains constant (usually as a heavy or weighted plate), and the two-sided grills have a preset thickness of the food contemplated to be produced. Furthermore, the heavy presses weigh many pounds, and are simply not as practical to produce (require more materials), store or transport because they are heavy. The manual presses have the disadvantage in that they require constant or frequent application of pressure to achieve the desired effect.

What is needed is an easy-to-use, lightweight cooker for making poultry, meat, and fish of any shape and size the users want. A great variation of foods of varying shapes, sizes, and thickness can be cooked using the press lock cooker of the present invention.

### SUMMARY

This invention meets the current need for such a cooker. A novel press lock cooker for making poultry, meat, and fish is provided. The preferred embodiment of the press lock cooker of the present invention is a frying pan with a plurality of substantially vertical channels in the walls of the frying pan, each channel having a plurality of slots or horizontal channels extending substantially horizontally in the walls of the frying pan from each channel, and a substantially flat-bottomed cover with a handle and a plurality of cooperating protrusions reciprocal in number to the number of channels, where the protrusions of the cover are capable of interlocking with the slots in walls of the frying pan to lock in and cook poultry, meat, and fish of different shapes and sizes in the restaurant or home environment. Food such as poultry (chicken for example) may also be cooked to be crispy under pressure using the press lock cooker.

Yet another embodiment of the press lock cooker of the present invention is a frying pan with a plurality of short protrusions extending inward towards the center of the frying pan from at or below the upper edge of the frying pan, and a substantially flat-bottomed cover with a handle and a reciprocal plurality of cooperating protrusions capable of interlocking with the protrusions on the frying pan to cook poultry, meat, and fish of different shapes and sizes in the restaurant or home environment.

The cover of the press lock cooker may be comprised of two parts: an upper part with a handle and a reciprocal plurality of cooperating protrusions capable of interlocking with the protrusions of the press lock cooker, and a substantially flat-bottomed lower part connected to the upper part by an adjustable screw or different means that allow the user to regulate the height of the lower part over the meat (and the distance between the bottom of the frying pan and the substantially flat-bottomed lower part).

The upper part of the cover is preferably removably attachable to the lower part of the cover for the ease of removing the bottom part and easy cleaning. The preferred method of attachment of the upper part to the lower part is by using a screw permanently mounted on the upper side of the lower part, preferably terminating in a handle, for example a knob, above the upper part. However, other methods of attachment may be used, such as latches and other means known in the art.

### DRAWINGS

These features, aspects and advantages of the novel press lock cooker and a kit for making poultry, meat, and fish will become further understood with reference to the following description and accompanying drawings where

FIG. 1 is a top side view of one embodiment of the frying pan and cover of the press lock cooker of the present invention, having six vertical channels and six protrusions;

FIG. 2 is a top down view of another embodiment the frying pan of the press lock cooker of the present invention, having eight vertical channels;

FIG. 3 is a top down view of the cover of the press lock cooker of the present invention illustrate, having eight protrusions;

FIG. 4 is a top down view of the cover of another embodiment of the press lock cooker of the present invention, having four protrusions;

FIG. 5 is an enlarged side view of one substantially vertical channel and its substantially horizontal channels in the wall of the frying pan of the press lock cooker of the present invention;

FIG. 6 is an enlarged side view of another embodiment of one substantially vertical channel and its substantially horizontal channels in the wall of the frying pan of the press lock cooker of the present invention;

FIG. 7 is an enlarged side view of yet another embodiment of one substantially vertical channel and its substantially horizontal channels in the wall of the frying pan of the press lock cooker of the present invention;

FIG. 8 is a top down view of another embodiment the frying pan of the press lock cooker of the present invention, having four inward protrusions; and

FIG. 9 is a top side view of the cover of the embodiment of the press lock cooker of the present invention illustrated in FIG. 8, having four outward protrusions and a top part and a bottom part.

### DESCRIPTION

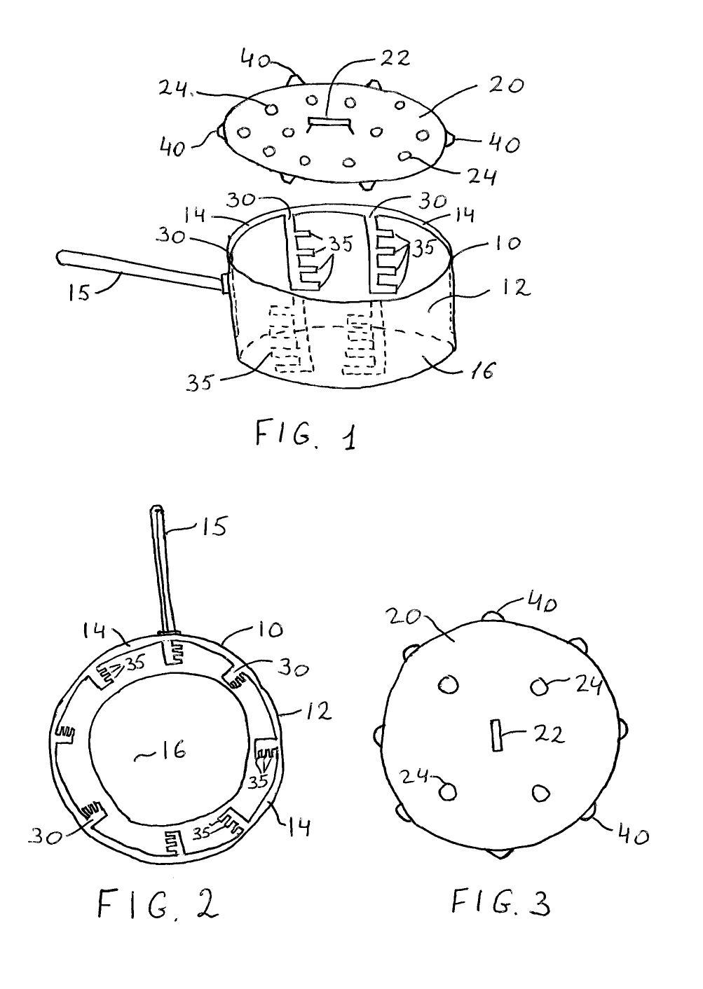

As illustrated in FIGS. 1 and 2, the preferred embodiment of the press lock cooker of the present invention comprises a substantially round pan or frying pan 10 with a substantially vertical wall 12, the frying pan 10 being suitable for cooking poultry, meat, and fish, and a cooperating cover 20. The frying pan 10 has at least two substantially vertical channels 30 in the wall 12 of the frying pan 10, where the channels 30 extend from the upper edge or rim 14 of the frying pan 10 and terminate at a predetermined height above the bottom 16 of the frying pan 10. The embodiment illustrated in FIG. 1 has six substantially vertical channels 30. The frying pan 10 may include a handle 15.

Each channel 30 has at least one, but preferably at least two substantially horizontal channels 35 extending substantially horizontally in the wall 12 of the frying pan 10 from each channel 30. Having more slots allows for greater adjustability of the height of the cover 20 over the bottom 16. The wall 12 of the frying pan 10 is preferably at least two inches high and includes several substantially horizontal channels 35 extending from channels 30 in the wall 12. The channel 30 and the lowest substantially horizontal channel 35 may terminate an inch or half-an-inch above the bottom 16 of the frying pan 10, which has to be determined during the design and manufacture of the specific embodiment of the press lock cooker. The wall 12 of the frying pan 10 should be of sufficient thickness to allow for the channels 30 and substantially horizontal channels 35. The channels 30 and substantially horizontal channels 35 preferably have the same depth in the wall 12 of the frying pan 10.

The cover 20 is a substantially flat-bottomed cover with a handle 22 and a plurality of cooperating protrusions 40 reciprocal in number to the number of channels 30. In the embodiment illustrated in FIG. 1, there are six cooperating protrusions 40 corresponding to the six substantially vertical channels 30. The handle 22 may be thermally insulated so as to prevent accidental burning if touched by the user when it is hot. The cover 20 may also have one or more apertures 24 for the steam to escape when the food is cooked. This serves several purposes: relieving the pressure that forms in the frying pan 10, between the wall 12, bottom 16 and cover 20; allowing the excess moisture to evaporate to cook food that is less soggy; and reducing the weight of the cover 20 and the amount of material needed to manufacture it.

Both the frying pan 10 and the cover 20 may be manufactured from the commercially used materials: cast iron, stainless steel, ceramic and other suitable materials and combinations thereof known in the art. For example the cover 20 may be made from glass, with a steel rim including the protrusions 40 pursuant to the disclosure of the present invention.

The cover 20 is sized to be slightly less in diameter than the diameter of the frying pan 10 when measured from the inner surface of the wall 12. The protrusions 40 are sized to be of such length that the combined diameter of the frying pan 10, when measured from the inner surface of the wall 12, and the length of two approximately opposite protrusions 40 are greater than the diameter of the frying pan 10 when measured from the inner surface of the wall 12, but slightly less than the combined diameter of the frying pan 10 measured from the inner surface of the wall 12 and the depth of the reciprocating channels 30.

The protrusions 40 are positioned on the cover 20 in a reciprocal fashion to the channels 30, and preferably spaced equidistantly from one another, just as the channels 30 should be. The protrusions 40 are sized so that they are able to pass through the channels 30 when the cover 20 is inserted into the frying pan 10, but the protrusions 40 are engaged by the substantially horizontal channels 35 when the cover 20 is twisted or rotated in the direction of the substantially horizontal channels 35. It should be noted that the figures illustrate an embodiment that utilizes a right-hand twist or rotating motion to lock the cover 20 in place because the substantially horizontal channels 35 are on the right side of each channel 30 from which the substantially horizontal channels 35 extend, but the substantially horizontal channels 35 may also be on the left side of each channel 30 and then the twist or rotating motion of the cover 20 to lock it will be left-handed.

When in use, the user positions the food to be cooked on the bottom 16 of the frying pan 10, takes the cover 20 by the handle 22, aligns the protrusions 40 on the cover 20 with the channels 30 in the wall 12 of the frying pan 10, and inserts the cover 20 into the frying pan 10, keeping the cover 20 substantially parallel to the bottom 16 so that the cooperating protrusions 40 pass unimpeded through the channels 30 until the cover 20 comes in contact with the food on the bottom 16 of the frying pan 10. When the cover 20 is on top of the food that is to be cooked, the user presses the cover 20 to press the food to the thickness that is desired, and, while applying constant pressure to the cover 20, aligns the protrusions 40 with the substantially horizontal channels 35 that will yield the desired height of the cover 20 over the bottom 16, which equates to the desired thickness of the food to be pressed, and twists or rotates the cover 20 clockwise so that the protrusions 40 are substantially within the substantially horizontal channels 35. The user then releases the handle 22 of the cover 20, which should remain securely in place propped up and held by the springing action of the pressed food but also held in place by the substantially horizontal channels 35 that engaged the protrusions 40.

The food is then cooked at the intensity desired, and the thickness of the food, i.e., poultry, meat, and fish, may be more or less depending on the level of compression by the cover 20 selected by the user, and it determines how well and how fast the food cooks.

Although the press lock cooker of the present invention will work with only two substantially vertical channels 30 in the wall 12 of the frying pan 10, which channels 30 should be substantially diametrically opposite in such configuration, it is preferable to have three or more substantially vertical channels 30 in the wall 12 of the frying pan 10 for secure, non-wobbling retention of the cover 20. When there are three or more substantially vertical channels 30 in the wall 12 of the frying pan 10, the substantially vertical channels 30 are preferably equidistantly positioned from one another in the wall 12 of the frying pan 10. There may be many variations of the present invention, employing three to eight vertical channels 30 in the wall 12 of the frying pan 10.

An enlarged view of one substantially vertical channel 30 and its corresponding substantially horizontal channels 35 are illustrated in FIG. 5, where the wall 12 of the frying pan 10 has the channels cut in the wall 12 starting at the upper edge 14. For even more secure retention of the cover 20, the ends of the substantially horizontal channels 35 may be slanted slightly upwards, or the substantially horizontal channels 35 may be U-shaped or inverted U-shaped as illustrated in FIGS. 6 and 7 to facilitate better retention. The present invention may also use leaf springs or another mechanism to snap-in and retain the cover 20.

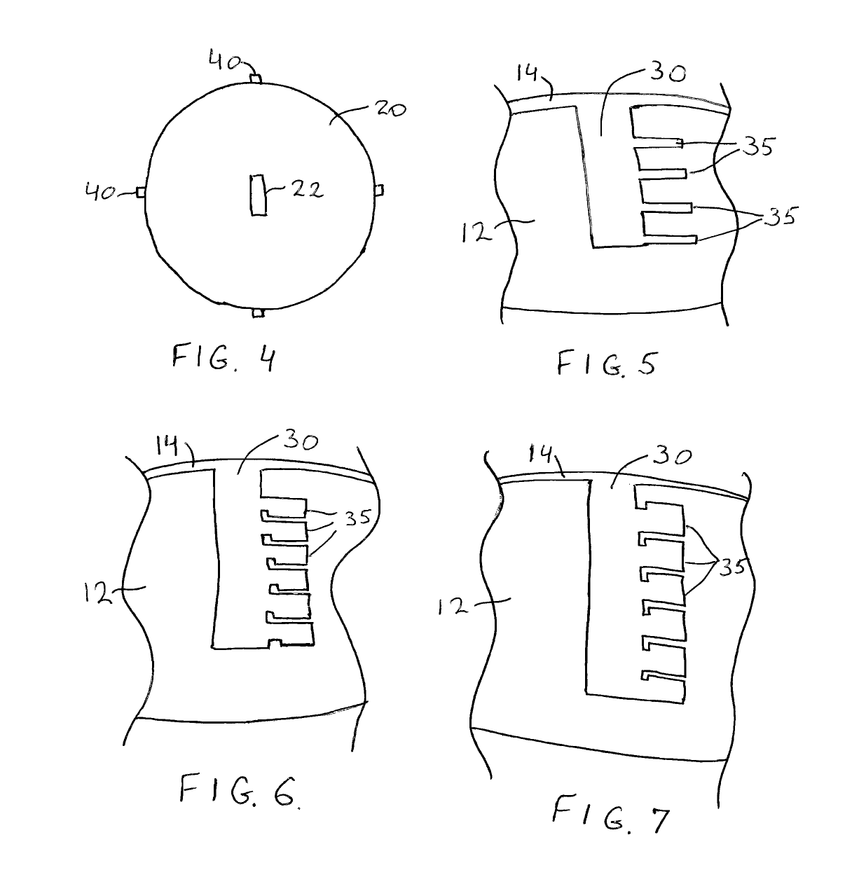

The protrusions 40 are substantially planar, being substantially in the same plane as the cover 20. The protrusions 40 are thus also substantially parallel to the bottom 16 of the frying pan 10. The protrusions 40 look like outward gear teeth, and they may be substantially square as illustrated in FIG. 4, rectangular, trapezoidal as illustrated in FIG. 1, or semicircular as illustrated in FIG. 3. Although a square, rectangular, or trapezoidal protrusion 40 may engage the cooperating horizontal channel 35 better, the semicircular protrusions 40 would have less difficulty moving in and out of the substantially horizontal channels 35, experiencing less snags because a semicircle has no corners to snag on.

Although the preferred embodiment of the present invention utilizes and round frying pan 10 and a round cover 20, the frying pan 10 and, correspondingly, the cover 20 may be square or rectangular. The difference in use would be in the locking motion of the cover 20: the user would not be twisting or rotating the cover 20, but rather sliding the cover 20 so that the protrusions 40 are engaged by the substantially horizontal channels 35 of the walls.

If necessary, the user can unlock the cover 20 and press it further down and lock the cover 20 at horizontal channels 35 that are lower than the horizontal channels 35 in which the cover 20 was previously locked. This may be desirable when the food loses some of its mass or moisture and becomes thinner as the result of cooking.

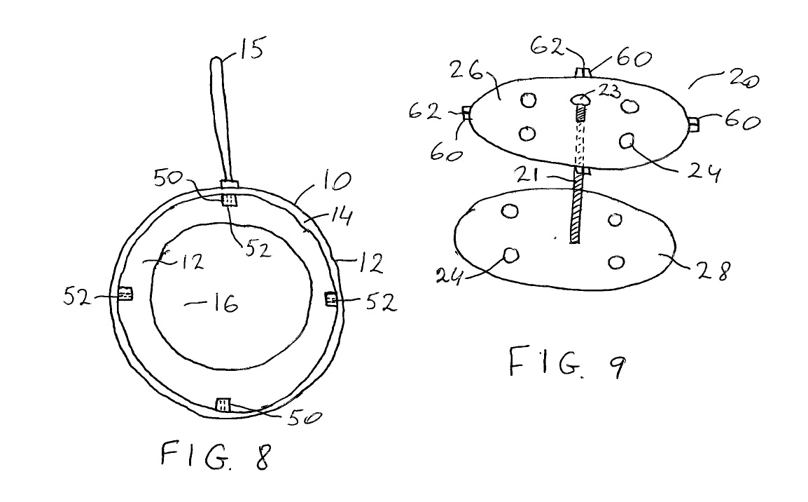

Another embodiment of the novel press lock cooker of the present invention is illustrated in FIG. 8. The press lock cooker comprises a frying pan 10 suitable for cooking poultry, meat, and fish and a cover 20, illustrated in FIGS. 1, 3, and 4 as a circular cover 20 having a handle 22 and apertures 24. The frying pan 10 has a wall 12, an upper edge or rim 14, and a bottom 16. The frying pan 10 is preferably a substantially round frying pan with at least two inward protrusions 50 extending from the wall 12, at or just below the upper edge or rim 14 of the frying pan 10, and aimed towards the center of the frying pan 10 in the plane substantially parallel to the bottom 16, which is the cooking surface of the frying pan 10. The inward protrusions 50 are substantially planar themselves, and they have the appearance of inward teeth that may be square, rectangular, trapezoidal or semicircular in shape.

In this alternative embodiment, the cover 20 has a number of outward protrusions 60 reciprocal to the number of the inward protrusions 50. As illustrated in FIG. 8, the number of both inward protrusions 50 and outward protrusions 60 is four each. The diameter of the cover 20 is slightly less than the distance between the ends of the inward protrusions 50 that are approximately opposite. The outward protrusions 60 are shaped and sized to cooperatively interface with the inward protrusions 50 and to hold the cover 20 in place.

To use the press lock cooker, the user places the food to be cooked on the bottom 16 of the frying pan 10. Unless the height of the cover 20 is adjustable, the top part of the food should typically be above the inward protrusions 50 in the frying pan 10. While holding the cover 20 by the handle 22, the user then inserts the cover 20 into the frying pan 10, and presses the food into the frying pan 10, thus compressing the food while allowing the cover 20 and the outward protrusions 40 of the cover 20 to pass between the inward protrusions 30 of the frying pan. When the outward protrusions 60 of the cover 20 are below the inward protrusions 50 of the frying pan 10, the user twists the cover 20 and positions the outward protrusions 60 of the cover 20 below the inward protrusions 50, thus locking the cover 20 in place. The combination of the food's resistance to the cover 20 and the friction between the outward protrusions 60 and the inward protrusions 50 will keep the cover 20 securely in place when the food is being cooked.

Although this embodiment of the press lock cooker will work with only two inward protrusions 50, which protrusions 50 should be substantially diametrically opposite in such configuration, it is preferable to have three or more protrusions 50 for secure, non-wobbling retention of the cover 20. When there are three or more inward protrusions 50, the inward protrusions 50 are preferably equidistantly positioned from one another along the wall 12 of the frying pan 10. There may be many variations of the present invention, employing three to eight inward protrusions 50.

As illustrated in FIG. 9, with this embodiment the cover 20 may be adjustable as follows: it may include a top part 26 and a bottom part 28 connected to the top part 26, preferably by an adjustable screw 21 or other adjustable means that is permanently attached to the bottom part 28 facing the top part 26 and is threaded through the top part 26. The top part 26 in this embodiment has the outward protrusions 60 for interfacing with the inward protrusions 50 of the frying pan 10, and the bottom part 28 is substantially flat for pressing the food down to the bottom 16 of the frying pan 10. The height of the bottom part 28 may be adjusted before the cover 20 is inserted into the frying pan 10 and locked in place, or the height of the bottom part 28 may be adjusted at any time if the adjustable screw 21 threaded through the top part 26 comes out of the top part 26 and has a handle or knob 23 for adjusting the height of the bottom part 28.

This embodiment of the cover 20 has a further advantage of enabling the user to adjust the height of the bottom part 28 after the cooking process has started if it is necessary to adjust the height because the adjustment may be made from the cover 20 closed position by simply rotating the handle or knob 23 to adjust the screw 21, thereby lowering or raising the bottom part 28 of the cover 20 and thus exerting more or less pressure on the food that is being cooked.

As further illustrated in FIGS. 8 and 9, the outward protrusions 60 and the inward protrusions 50 may have cooperating locking means such as a groove or a channel 62 in each of the outward protrusions 60 and a cooperating ridge 52 in each of the inward protrusions 50, further assisting in locking the cover 20 over the food in the frying pan 10 when the ridges 52 are caught by the groove or channel 62 after the cover 20 is twisted in place and the outward protrusions 60 overlap with and are below the inward protrusions 50. The arrangement may be reversed, with a groove or a channel 62 in each of the inward protrusions 50 and a cooperating ridge 52 in each of the outward protrusions 60 (not shown). This further prevents the outward protrusions 60 in the cover 20 from slipping from under the inward protrusions 50, even when the press lock cooker is oily or wet.

Instead of the groove or channel 62 and ridge 52 locking, other retaining configurations may be used: semi-spherical protrusion and cooperating semi-spherical depression in the cooperating inward protrusions 50 and outward protrusions 60, or any other number of cooperating protrusions and receptacles to further aid in retaining the cover 20 in the pan 10 and prevent it from slipping.

The above description of the disclosed preferred embodiments is provided to enable any person skilled in the art to make or use the invention. Various modifications to these embodiments will be readily apparent to those skilled in the art, and the principles described herein can be applied to other embodiments without departing from the spirit or scope of the invention and the subject matter of the present invention, which is broadly contemplated by the Applicant. The scope of the present invention fully encompasses other embodiments that may be or become obvious to those skilled in the art.

1. A novel press lock cooker, comprising:
(a) a pan having a bottom and a substantially vertical wall connected to the bottom, said wall having a plurality of substantially vertical channels therein and an upper edge, each substantially vertical channel extending from the upper edge of the substantially vertical wall to a predetermined distance above the bottom and having one or more substantially horizontal channels branching from the each substantially vertical channel; and
(b) a cooperating removable cover having a plurality of cooperating protrusions spaced and sized to pass unimpeded through the plurality of substantially vertical channels and engage with the one or more substantially horizontal channels.

2. The novel press lock cooker of claim 1, wherein the pan is a frying pan.

3. The novel press lock cooker of claim 1, wherein the pan further includes a handle attached to an exterior of the wall of the pan.

4. The novel press lock cooker of claim 1, wherein the pan is substantially circular.

5. The novel press lock cooker of claim 1, wherein the pan is substantially square or substantially rectangular.

6. The novel press lock cooker of claim 1, wherein the cover is substantially flat.

7. The novel press lock cooker of claim 1, wherein the cover further includes a handle.

8. The novel press lock cooker of claim 7, wherein the handle is thermally insulated.

9. The novel press lock cooker of claim 1, wherein the cover further includes at least one aperture.

10. A novel press lock cooker, comprising:
(a) a pan having a bottom and a substantially vertical wall with an upper edge connected to the bottom, said wall having a plurality of inward protrusions thereon, at or below the upper edge, each inward protrusion extending towards the center of the pan; and
(b) a cooperating removable cover having a plurality of cooperating outward protrusions spaced and sized so as to pass unimpeded between the plurality of inward protrusions and engage with the plurality of inward protrusions when the removable cover is inserted into the pan so that the plurality of outward protrusions are below the plurality of inward protrusions and moved to engage said plurality of outward protrusions and said plurality of inward protrusions.

11. The novel press lock cooker of claim 10, wherein the pan is a frying pan.

12. The novel press lock cooker of claim 10, wherein the pan further includes a handle attached to an exterior of the wall of the pan.

13. The novel press lock cooker of claim 10, wherein the pan is substantially circular, substantially square or substantially rectangular.

14. The novel press lock cooker of claim 10, wherein the cover is substantially flat.

15. The novel press lock cooker of claim 10, wherein the cover further includes a handle.

16. The novel press lock cooker of claim 15, wherein the handle is thermally insulated.

17. The novel press lock cooker of claim 10, wherein the cover further includes at least one aperture.

18. The novel press lock cooker of claim 10, wherein the cover includes a top part having the plurality of outward protrusions and a bottom part and wherein the position of the bottom part is adjustable relative to the top part.

19. The novel press lock cooker of claim 10, wherein each of the plurality of inward protrusions includes a protrusion and each of the plurality of outward protrusions includes a cooperating recess shaped and sized to accept the protrusion.

20. A novel press lock cooker, comprising:
(a) a pan having a bottom and a substantially vertical wall connected to the bottom, said wall having a plurality of substantially vertical channels therein and an upper edge, each substantially vertical channel extending from the upper edge of the substantially vertical wall to a predetermined distance above the bottom and having one or more substantially horizontal channels branching from the each substantially vertical channel; and
(b) a cooperating removable cover having a plurality of cooperating protrusions spaced and sized to pass unimpeded through the plurality of substantially vertical channels and engage with the one or more substantially horizontal channels when the removable cover is inserted into the pan, the plurality of cooperating protrusions pass through the plurality of substantially vertical channels, and the removable cover is moved to engage with the one or more substantially horizontal channels.
